(19) United States
(12) Patent Application Publication
(10) Pub. No.: US 2017/0156402 A1
(43) Pub. Date: Jun. 8, 2017

(54) ATOMIZER AND ELECTRONIC CIGARETTE COMPRISING SAME

(71) Applicant: KIMREE HI-TECH INC., ROAD TOWN, TORTOLA (VG)

(72) Inventor: Qiuming LIU, SHENZHEN (CN)

(21) Appl. No.: 15/317,496

(22) PCT Filed: Jun. 12, 2014
(86) PCT No.: PCT/CN2014/079746

§ 371 Date: Dec. 9, 2016

(51) Int. Cl. A24F 47/00; H05B 3/46; A24F 7/04

(52) U.S. Cl. CPC A24F 47/008; A24F 7/04; H05B 3/46

(57) ABSTRACT

An atomizer and an electronic cigarette comprising the same are provided. The atomizer comprises an atomization sleeve and an atomizer assembly contained in the atomization sleeve, a first filter and a second filter separated from each other are provided successively on one end of the atomizer assembly that is close to the smoking end; the first filter is breathable and is configured to prevent tobacco tar in smoke from exhausting, and the second filter is configured to discharge the smoke filtrated by the first filter; the second filter is made from breathable porous material; and is capable of deforming elastically when subjected to an external force. The first filter filtrates the tobacco tar for the first time; the suction nozzle is replaced by the second filter which may deform elastically; besides, the second filter may not be contaminated by the tobacco tar impurity adsorbed by the first filter.

### TECHNICAL FIELD

The present application relates to the field of daily electronic products, more specifically, relates to an atomizer and an electronic cigarette comprising the same.

### BACKGROUND

An electronic cigarette comprises an atomizer and a battery rod. The battery rod is used for supplying power to the atomizer assembly of the atomizer, and the atomizer assembly is capable of atomizing tobacco tar so as to produce smoke after being energized. The smoke further flows into an oral cavity of a user through a smoke channel and thus is inhaled by the user. In prior art, condensed or un-atomized tobacco tar is easily stored in the smoke channel, wherein the tobacco tar may be leaked out of the electronic cigarette by means of capillarity or gravity, which has greatly influence on the appearance and smoking effect of the electronic cigarette. And thus, the tobacco tar may be easily sucked in by the user during smoking. Furthermore, in prior art, a suction nozzle is generally fixed at a smoking end of the electronic cigarette and is configured to guide the smoke. As the suction nozzle is made from hard material, the tactile sensation of the electronic cigarette is far away from that of a real cigarette when the user is smoking.

In prior art, a special filter tip is provided to filtrate the smoke. However, the tobacco tar absorbed by the filter tip may be extruded with the clamping force applied by the oral cavity of the user during smoking. In order to solve the aforementioned drawbacks, a breather pipe that is made from hard material is inserted in the axis of the filter tip, wherein the breather pipe is arranged coaxially with the filter tip. In this way, the elastic deformation of the filter tip can be reduced when the clamping force applied by the oral cavity of the user is applied to the filter tip, and thus the amount of the tobacco tar extruded may be reduced as far as possible and the ventilation of the middle part of the filter tip may be ensured. However, with the smoking number increases, the tobacco tar is still extruded outside, and the user may suck in the tobacco tar. Additionally, when smoking, user may feel hard since elastic deformation will not be produced with the breather pipe made from hard material, and thus user experience is impacted. Furthermore, the user will suck in the tobacco tar since large particles tobacco tar without completely atomized may flow into the oral cavity via the breather pipe.

Therefore, the electronic cigarette in the prior art has a lot of drawbacks, and needs to be improved.

### BRIEF SUMMARY OF THE APPLICATION

To solve the drawbacks that the tobacco tar of the conventional electronic cigarette is easily leaked out, the user may suck in the tobacco tar and the tactile sensation of smoking end is poor, the present application provides an atomizer that may reduce the tobacco tar leakage as well as improve the tactile sensation of smoking end, and further provides an electronic cigarette comprising the atomizer aforementioned.

The technical solutions of the present application for solving the technical problems are as follows: In a first aspect, an atomizer configured to assemble with a battery rod to form an electronic cigarette is provided. Wherein an atomization sleeve and an atomizer assembly contained in the atomization sleeve, one end of the atomizer is configured as a smoking end, wherein a first filter and a second filter separated from each other are provided successively on one end of the atomizer assembly that is close to the smoking end; the first filter is breathable and is configured to prevent tobacco tar in smoke from exhausting; the second filter is configured to discharge the smoke filtrated by the first filter; the atomizer assembly and the second filter are provided on two sides of the first filter respectively; the second filter is contained in the smoking end and is made from breathable porous material; wherein the second filter is capable of deforming elastically when subjected to an external force, while the atomizer sleeve is a pipe body which is made from non-metallic materials and is capable of deforming elastically when subjected to an external force.

In one embodiment, an elastic fixing element is embedded into the atomization sleeve located at the smoking end and is configured to prevent the tobacco tar from leaking out of the wall of the atomization sleeve; the first filter is contained in the elastic fixing element.

In this embodiment, the elastic fixing element is connected to the atomization sleeve by an interference fit; the elastic fixing element includes a fixing sleeve body coated on the first filter, and an elastic sealing layer coated on the outer peripheral face of the fixing sleeve body; wherein the hardness of the fixing sleeve body is greater than the hardness of the elastic sealing layer.

In this embodiment, the elastic fixing element is connected to the atomization sleeve by an interference fit, and the elastic fixing element abuts against the atomizer assembly.

In this embodiment, the elastic fixing element includes a smoke inlet facing towards the atomization assembly and a smoke outlet away from the atomization assembly, and the smoke inlet and the smoke outlet are arranged coaxially; the first filter is located between the smoke inlet and the smoke outlet; the diameter of the smoke inlet is greater than the diameter of the smoke outlet, in such a way that the tobacco tar is capable of being exhausted from the smoke inlet when the first filter is extruded.

In this embodiment, the elastic fixing element is in form of a cylinder; the elastic fixing element includes a resisting portion in form of a disc and a connection portion; the resisting portion abuts against the atomization assembly; wherein the connection portion is formed by extending axially in the direction facing towards the second filter from the edge of the resisting portion, and is in form of a hollow cylinder; one end of the connection portion that is far away from the resisting portion is configured as the smoke outlet, while the smoke inlet is a breathing hole which is defined in the center of the resisting portion and is facing directly towards the atomization assembly; the first filter is contained in the connection portion.

In this embodiment, the second filter is separated from the elastic fixing element, wherein the second filter is connected to the atomization sleeve by an interference fit; one end of the second filter that is far away from the first filter is at a same level as one end of the atomization sleeve, in such a way that a flat surface is formed.

In another embodiment,

the second filter is inserted into the elastic fixing element in part, and part of the second filter that extends out of the elastic fixing element is connected to the atomization sleeve by an interference fit;

or the second filter is completely inserted into the elastic fixing element;

In this embodiment, the inner wall of the connection portion extends in the radial direction in such a way that an annular step is formed; the first filter is contained in the annular step; one end of the second filter abuts against the annular step, while the other end extends from the elastic fixing element, and is at a same level as one end of the atomization sleeve, in such a way that a flat surface is formed.

In this embodiment, a first chamfer is provided on the inner lateral edge of the annular step that is facing towards the second filter.

In another embodiment, the atomization assembly includes a heating element, a breathing pipe arranged in the axial direction of the atomization sleeve and contained in the heating element, non-woven fabrics coated on an outer peripheral face of the breathing pipe and oil cottons coated on an outer peripheral face of the non-woven fabrics; wherein the breathing hole is directly facing towards the breathing pipe, and the bore diameter of the breathing hole is less than the inside diameter of the breathing pipe.

In this embodiment, a second chamfer is formed at the opening of the breathing hole that is facing towards the atomization assembly, and the breathing pipe abuts against the second chamfer.

In another embodiment, a third chamfer is formed at the opening of the breathing hole that is far away from the atomization assembly, and is convenient for the tobacco tar in the first filter to flow back.

In another embodiment, the first filter and the second filter are arranged coaxially along the atomization sleeve; a gap is formed between the second filter and the first filter, and is configured to deliver the smoke filtrated by the first filter to the second filter; the axial length of the gap is 1-3 mm.

In a second aspect, another atomizer configured to assemble with a battery rod to form an electronic cigarette is provided. Wherein an atomization sleeve and an atomizer assembly contained in the atomization sleeve, one end of the atomizer is configured as a smoking end, wherein a first filter and a second filter separated from each other are provided successively on one end of the atomizer assembly that is close to the smoking end; the first filter is breathable and is configured to prevent tobacco tar in smoke from exhausting; the second filter is configured to discharge the smoke filtrated by the first filter; the atomizer assembly and the second filter are provided on two sides of the first filter respectively; the second filter is contained in the smoking end and is made from breathable porous material; wherein the second filter is capable of deforming elastically when subjected to an external force, while the atomizer sleeve is a pipe body which is made from non-metallic materials and is capable of deforming elastically when subjected to an external force;

an elastic fixing element is embedded into the atomization sleeve located at the smoking end and is configured to prevent the tobacco tar from leaking out of the wall of the atomization sleeve; the first filter is contained in the elastic fixing element; the elastic fixing element is connected to the atomization sleeve by an interference fit; the elastic fixing element includes a fixing sleeve body coated on the first filter, and an elastic sealing layer coated on the outer peripheral face of the fixing sleeve body; wherein the hardness of the fixing sleeve body is greater than the hardness of the elastic sealing layer;

the elastic fixing element includes a smoke inlet facing towards the atomization assembly and a smoke outlet away from the atomization assembly, and the smoke inlet and the smoke outlet are arranged coaxially; the first filter is located between the smoke inlet and the smoke outlet; the diameter of the smoke inlet is greater than the diameter of the smoke outlet, in such a way that the tobacco tar is capable of being exhausted from the smoke inlet when the first filter is extruded;

the fixing sleeve body is in form of a cylinder and includes a resisting portion in form of a disc and a connection portion; the resisting portion abuts against the atomization assembly; the connection portion is formed by extending axially in the direction facing towards the second filter from the edge of the resisting portion, and is in form of a hollow cylinder; one end of the connection portion that is far away from the resisting portion is configured as the smoke outlet; the smoke inlet is a breathing hole which is defined in the center of the resisting portion and is facing directly towards the atomization assembly; the first filter is contained in the connection portion.

In a third aspect, an electronic cigarette is provided. The electronic cigarette comprises an atomizer and a battery rod connected to each other; wherein the atomizer comprises an atomization sleeve and an atomizer assembly contained in the atomization sleeve, one end of the atomizer is configured as a smoking end, wherein a first filter and a second filter separated from each other are provided successively on one end of the atomizer assembly that is close to the smoking end; the first filter is breathable and is configured to prevent tobacco tar in smoke from exhausting; the second filter is configured to discharge the smoke filtrated by the first filter; the atomizer assembly and the second filter are provided on two sides of the first filter respectively; the second filter is contained in the smoking end and is made from breathable porous material; wherein the second filter is capable of deforming elastically when subjected to an external force, while the atomizer sleeve is a pipe body which is made from non-metallic materials and is capable of deforming elastically when subjected to an external force.

In the electronic cigarette, an elastic fixing element is embedded into the atomization sleeve located at the smoking end and is configured to prevent the tobacco tar from leaking out of the wall of the atomization sleeve; the first filter is contained in the elastic fixing element.

In the electronic cigarette, wherein, the elastic fixing element is connected to the atomization sleeve by an interference fit; the elastic fixing element includes a fixing sleeve body coated on the first filter and an elastic sealing layer coated on the outer peripheral face of the fixing sleeve body; wherein the hardness of the fixing sleeve body is greater than the hardness of the elastic sealing layer.

In the electronic cigarette, the elastic fixing element is connected to the atomization sleeve by an interference fit, and the elastic fixing element abuts against the atomizer assembly;

the elastic fixing element includes a smoke inlet facing towards the atomization assembly and a smoke outlet away from the atomization assembly, and the smoke inlet and the smoke outlet are arranged coaxially; the first filter is located between the smoke inlet and the smoke outlet; the diameter of the smoke inlet is greater than the diameter of the smoke outlet, in such a way that the tobacco tar is capable of being exhausted from the smoke inlet when the first filter is extruded;

the elastic fixing element is in form of a cylinder; the elastic fixing element includes a resisting portion in form of a disc and a connection portion; the resisting portion abuts against the atomization assembly; wherein the connection portion is formed by extending axially in the direction facing towards the second filter from the edge of the resisting portion, and is in form of a hollow cylinder; one end of the connection portion that is far away from the resisting portion is configured as the smoke outlet, while the smoke inlet is a breathing hole which is defined in the center of the resisting portion and is facing directly towards the atomization assembly; the first filter is contained in the connection portion;

the axial length of the gap between the second filter and the first filter is 1-3 mm.

In the electronic cigarette, the battery rod includes a battery sleeve, a battery contained in the battery sleeve, a lamp cap inserted in one end of the battery sleeve that is far away from the atomizer, and a controller embedded into the lamp cap;

the battery sleeve is integrated with the atomization sleeve; the battery sleeve and the atomization sleeve are made from plastic material;

the lamp cap includes a lamp body and an extending portion; the extending portion is hollow and is formed at a circumference of the lamp body with its diameter reduced; and the extending portion extends axially towards the battery sleeve; the battery sleeve is sheathed on the extending portion; the controller is contained in the extending portion, and the lamp body is covered on the battery sleeve; an air inlet groove is defined on the side wall of the lamp body that is facing towards the battery sleeve, wherein the air inlet groove extends to the edge of the lamp body; a breathing groove is defined on the extending portion, wherein the breathing groove passes through the extending portion in axial direction and is communicated with the air inlet groove; a notch is defined in the extending portion, wherein the notch passes through the extending portion in the longitudinal direction and is configured for the wires connected to the controller to pass through.

When implementing the atomizer and the electronic cigarette with the atomizer of the present application, the following advantageous effects can be achieved: a first filter is provided and is capable of filtrating the tobacco tar for the first time, and the drawback that the tobacco tar easily leaks out can be avoided. In the present application, the suction nozzle is replaced by a second filter which may deform elastically while being clamped by the oral cavity of the user. In this way, the electronic cigarette can simulate the tactile sensation of a real cigarette while the user is smoking. Additionally, as the second filter is separated from the first filter, the second filter may not be contaminated by the tobacco tar impurity adsorbed by the first filter, and the drawbacks in prior art that tobacco tar is extruded while the suction nozzle is clamped by the oral cavity of the user or sucking in large particles tobacco tar can be solved. The smoke smoked by the user has little impurity and the taste is pure.

### BRIEF DESCRIPTION OF THE DRAWINGS

The present application will be further described with reference to the accompanying drawings and embodiments in the following, in the accompanying drawings:

FIG. 1 is a schematic view of the first implementing method of the first embodiment of an electronic cigarette according to the present application;

FIG. 2 is an exploded view of the first implementing method of the first embodiment of an electronic cigarette according to the present application;

FIG. 3 is a schematic view of the second implementing method of the first embodiment of an electronic cigarette according to the present application;

FIG. 4 is a part schematic view of the second embodiment of an electronic cigarette according to the present application; and

FIG. 5 is a schematic view of a lamp cap of an electronic cigarette according to the present application.

### DETAILED DESCRIPTION OF THE PREFERRED EMBODIMENTS

To make the objects, technical schemes and advantages more clearly, the present application may be further described in detail with reference to the accompanying drawings and embodiments.

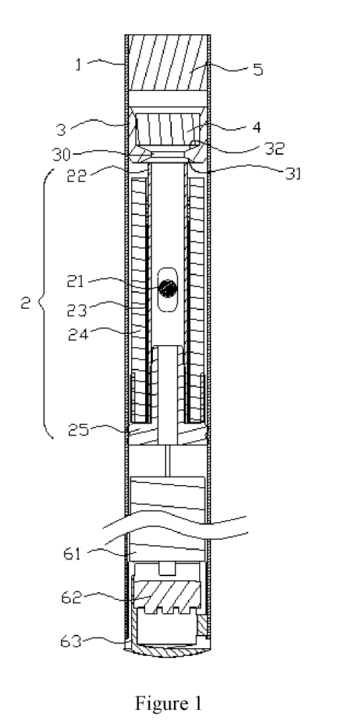

Referring to FIG. 1, an electronic cigarette comprises an atomizer and a battery rod. Wherein, the atomizer and the battery rod are arranged coaxially and are connected to each other. In this case, one end of the atomizer is configured as a smoking end. In a first embodiment, the atomizer includes an atomization sleeve 1 that is in form of a cylinder, an atomizer assembly 2, an elastic fixing element 3, a first filter 4 and a second filter 5 located in the smoking end. In this case, the atomizer assembly 2, the elastic fixing element 3, the first filter 4 and the second filter 5 are all contained in the atomization sleeve 1. The battery rod includes a battery sleeve, a battery 61 contained in the battery sleeve, a lamp cap 63 inserted in one end of the battery sleeve that is far away from the atomizer, and a controller 62 embedded into the lamp cap 63. Wherein, the atomization sleeve 1 is a pipe body which is made from non-metallic material. When subjected to an external force, the atomization sleeve may deform elastically. In this case, the atomization sleeve 1 is made from plastic. Of course, the atomizer sleeve 1 can be made from any other non-metallic materials except plastic, and the material is not limited here.

The connection between the atomizer and the battery rod is not limited here. For example, in the case that the atomization sleeve and the battery sleeve are isolated from each other, the atomization sleeve and the battery sleeve may be detachably connected to each other. While in this case, when the atomization sleeve and the battery sleeve are in fact the same sleeve, the atomization sleeve 1 is integrated with the battery sleeve, and thus the atomization sleeve and the battery sleeve are formed in one-piece. Furthermore, since the atomization sleeve and the battery sleeve are made from plastic material, the electronic cigarette is soft and the tactile sensation of the electronic cigarette is close to a real cigarette.

The elastic fixing element 3 is located at one end of the atomization assembly 2 that is close to one end of the smoking end for exhausting smoke, and is further embedded into the atomization sleeve 1, in order to prevent the tobacco tar from leaking out of the wall of the atomization sleeve 1. Advantageously, the elastic fixing element 3 is connected to the atomization sleeve 1 by an interference fit. Two ends of the elastic fixing element 3 are communicated with each other, and the first filter 4 is contained in the elastic fixing element 3. In this case, the elastic fixing element 3 is made from silicone material. Of course, the elastic fixing element 3 can be made from rubber or other materials as long as the elastic fixing element 3 may deform elastically, and the materials are not limited here. The second filter 5 is provided on one side of the first filter 4 that is far away from the atomization assembly 2, and is made from breathable porous material. The first filter 4 is separated from the second filter 5. When subjected to a clamping external force generated by the oral cavity, the first and the second filter may deform elastically.

Wherein, the first filter 4 and the second filter 5 can be made from the materials such as cellulose acetate, polypropylene fiber (PP fiber), PET fiber, acetate fiber, viscose fiber, polyester fiber, polyamide fiber, polyacrylonitrile fiber, formalized polyvinyl alcohol fiber, sponge or breathable foam.

The first filter 4 is configured to prevent the tobacco tar in the smoke from exhausting, so that the tobacco tar of the electronic cigarette may not be leaked out easily. For example, the first filter 4 is made from the material that can adsorb the tobacco tar directly or the material with minimal pore size. The second filter 5 and the first filter 4 are arranged coaxially, and are separated from each other. In this case, a gap is formed between the second filter 5 and the first filter 4. The axial length of the gap is 1-3 mm, and is preferably 2 mm. In this way, the second filter 5 may not be contaminated by the tobacco tar impurity adsorbed by the first filter 4. As most of the tobacco tar has been stopped by the first filter 4, only a small quantity of the tobacco tar may be absorbed by the second filter 5. In this way, no tobacco tar is extruded from the extruded second filter 5 when the user are smoking the electronic cigarette and clamping the smoking end. In this way, the smoke smoked by the user has little impurity and the taste is pure. Additionally, in this case, a suction nozzle is replaced by the second filter 5 which may deform elastically while being clamped by the oral cavity of the user. In this way, the electronic cigarette can simulate the tactile sensation of the real cigarette while the user is smoking. Thereby, the drawback in prior art that the tobacco tar is extruded while the suction nozzle is clamped by the oral cavity of the user can be solved.

The elastic fixing element 3 includes a smoke inlet facing towards the atomization assembly 2 and a smoke outlet away from the atomization assembly 2, wherein the smoke inlet and the smoke outlet are arranged coaxially. The first filter 4 is located between the smoke inlet and the smoke outlet. The diameter of the smoke inlet is greater than the diameter of the smoke outlet. Therefore, instead of being extruded to the space closed to the smoking end, the tobacco tar can be exhausted from the smoke inlet and further back to the atomization assembly 2 when the first filter 4 is extruded.

In the first embodiment, the second filter 5 is connected to the atomization sleeve 1 by an interference fit, and the second filter 5 is separated from the elastic fixing element 3. One end of the second filter 5 that is far away from the first filter 4 is at a same level as one end of the atomization sleeve 1, so that a flat surface is formed.

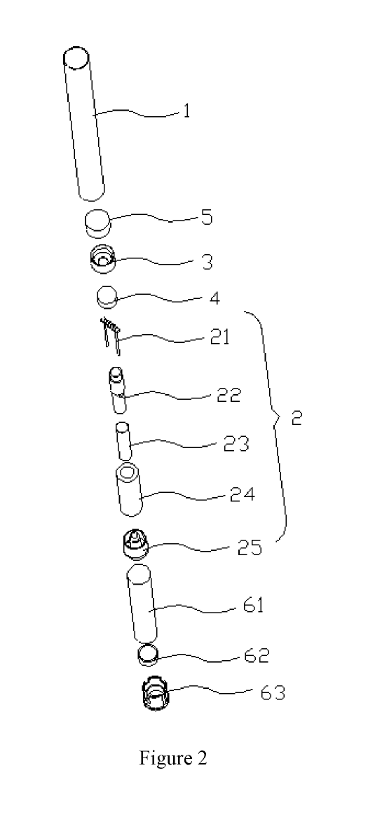

Referring to FIG. 1 and FIG. 2, the elastic fixing element 3 is in form of a cylinder, and includes a resisting portion in form of a disc and a connection portion. Wherein the connection portion is formed by extending axially in the direction facing towards the second filter 5 from the edge of the resisting portion, and is in form of a hollow cylinder. The connection portion abuts against the atomization assembly 2. In this case, one end of the connection portion that is far away from the resisting portion is configured as the smoke outlet. The smoke inlet is a breathing hole 30 which is defined in the center of the resisting portion and is facing directly towards the atomization assembly 2. The first filter 4 is contained in the connection portion. A second chamfer 31 is formed at the opening of the breathing hole 30 that is facing towards the atomization assembly 2. A third chamfer 32 is formed at the opening of the breathing hole 30 that is far away from the atomization assembly 2, and is convenient for the tobacco tar in the first filter 4 to flow back.

In this case, the atomization assembly 2 includes a heating element 21, an atomization base 25, a breathing pipe 22, non-woven fabrics 23 and oil cottons 24. In this case, the atomization base 25, the breathing pipe 22, the non-woven fabrics 23 and the oil cottons 24 are arranged in the axial direction of the atomization sleeve 1. Wherein, the bore diameter of the breathing hole 30 is less than the inner diameter of the breathing pipe 22.

The atomization base 25 includes a base in form of a disc. The base is connected to the atomization sleeve 1 by an interference fit. A through-hole is defined in the center of the base in axial direction and is configured for air to circulate. A first annular projection is formed by axially extending from the peripheral edge of the through-hole in the direction of facing towards the first filter 4. The breathing pipe 22 is sheathed on the first annular projection. One end of the breathing pipe 22 abuts against the base and the other end abuts against the second chamfer 31, and thus the breathing hole 30 is located directly opposite the breathing pipe 22. The heating element 21 is contained in the breathing pipe 22. In particular, two through-holes are symmetrically defined on the wall of the breathing pipe 22, the heating element 21 traverses to the inner of the breathing pipe 22, and two ends of the heating element 21 are positioned on the two through-holes respectively. The non-woven fabrics 23 are coated on the outer peripheral face of the breathing pipe 22, and the oil cottons 24 are further coated on the outer peripheral face of the non-woven fabrics 23. A second annular projection is formed at a circumference of an inner wall of an edge on one side of the base that is facing towards the first filter 4, with the diameter thereof reduced, wherein the second annular projection is sheathed outside of the oil cottons 24.

The advantage of the third chamfer 32 is that when the tobacco tar adsorbed by the first filter 4 flows back by extruding or the tobacco tar stopped by the first filter 4 flows back, the tobacco tar will not be stored at the floor wall of the elastic fixing element 3 and can easily flow back to the atomization assembly. As the bore diameter of the breathing hole 30 is less than the inner diameter of the breathing pipe 22, most of the tobacco tar is back to the breathing pipe 22 when the first filter 4 is extruded, and the probability of flowing tobacco tar into the atomization sleeve 1 is reduced. Besides, it is convenient to atomizing the returned tobacco tar again as the heating element 21 is contained in the breathing pipe 22. Furthermore, as the bore diameter of the breathing hole 30 is less than the inner diameter of the breathing pipe 22, the smoke may be condensed easily when entering into the elastic fixing element 3. And in this case, the second chamfer 31 may help the condensational tobacco tar to return back. The breathing pipe 22 abuts against the second chamfer 31 of the resisting portion; in this way, the first filter 4 is avoided from directly contacting with the oil cottons 24, and thus, the first filter 4 is prevented from adsorbing the tobacco tar in the oil cottons 24.

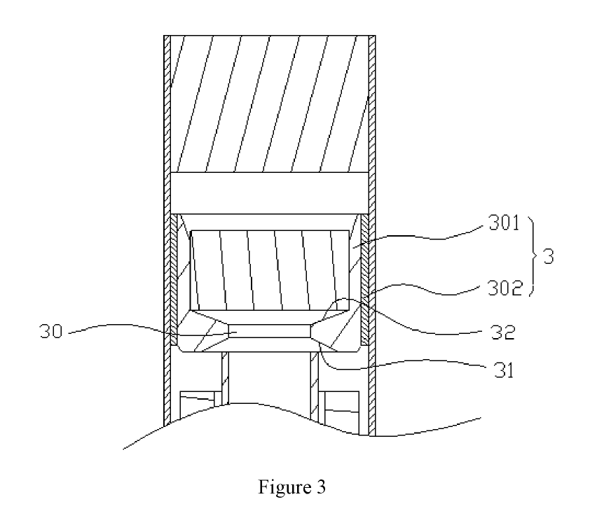

In the first implementing method of the first embodiment, the elastic fixing element 3 has an integral structure; preferably the elastic fixing element 3 may be an assembled element. Referring to FIG. 3, in the second implementing method of the first embodiment, the elastic fixing element 3 includes a fixing sleeve body 301 coated on the first filter 4 and an elastic sealing layer 302 coated on the outer peripheral face of the fixing sleeve body 301. The hardness of the fixing sleeve body 301 is greater than the hardness of the elastic sealing layer 302. The structure of the fixing sleeve body 301 is the same as the structure of the elastic fixing element 3 with an integral structure disclosed in the aforementioned first implementing method, and will not be described detailed here. Compared with the first implementing method, in the second implementing method, the fixing sleeve body 301 is preferably made from hard materials, such as metal. For example, the fixing sleeve body 301 may be made from rigid material. The elastic sealing layer 302 is made from silica gel, plastic or rubber like elastic material. In this case, the elastic sealing layer 302 is in form of a cylinder adapted to the fixing sleeve body 301. Preferably, considering the elasticity and the leakproofness of the elastic sealing layer 302, the thickness of the elastic sealing layer 302 is 1-2 mm.

Compared with the first implementing method, in the second implementing method, the elastic sealing layer 302 can be sealed and keep elastic. When extruded, the sealing layer 302 may deform, and thus the tactile sensation of the electronic cigarette is similar to that of real cigarette. While the fixing sleeve body 301 will not deform when being extruded, so that the first filter 4 in the fixing sleeve body 301 will not be extruded. In this way, it will effectively prevent the tobacco tar from being extruded and contaminating other components.

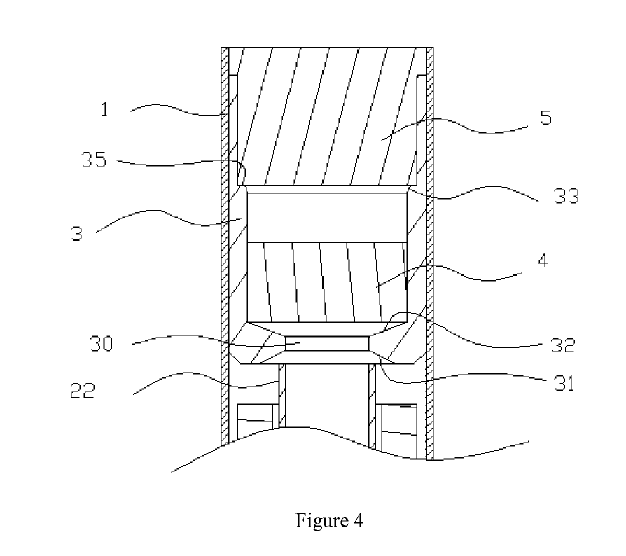

In order to separate the first filter 4 from the second filter 5, in the first embodiment, the second filter 5 is separated from the elastic fixing element 3, and the second filter 5 is fixed by connecting to the atomization sleeve 1 by an interference fit. Referring FIG. 4, in the second embodiment, the second filter 5 is inserted into the elastic fixing element 3 in part, and part of the second filter 5 that extends out of the elastic fixing element 3 is connected to the atomization sleeve 1 by an interference fit. That is, the fixation of the second filter 5 enhances the connection to the elastic fixing element 3.

The elastic fixing element 3 is in form of a cylinder and includes a resisting portion in form of a disc and a connection portion. Wherein the connection portion is formed by extending axially in the direction facing towards the second filter 5 from the edge of the resisting portion, and is in form of a hollow cylinder. One end of the connection portion that is far away from the resisting portion is configured as the smoke outlet. The smoke inlet is a breathing hole 30 which is defined in the center of the resisting portion and is facing directly the atomization assembly 2. A second chamfer 31 is formed at the opening of the breathing hole 30 that is facing towards the atomization assembly 2. A third chamfer 32 is formed at the opening of the breathing hole 30 that is far away from the atomization assembly 2, and is convenient for the tobacco tar in the first filter 4 to flow back. This part is the same as the first embodiment and will not be described in detail here.

Unlike the first embodiment, in order to separate the first filter 4 from the second filter 5, the inner wall of the connection portion extends in the radial direction and thus an annular step 35 is formed. The first filter 4 is contained in the annular step 35, and is separated at a distance from the end of the annular step 35 that is facing towards the second filter 5. One end of the second filter 5 abuts against the annular step 35, while the other end extends from the elastic fixing element 3, and is at a same level as one end of the atomization sleeve 1, so that a flat surface is formed. The resisting portion abuts against the atomization assembly 2.

Furthermore, compared with the first embodiment, in the second embodiment, as the end of the second filter 5 is inserted in the elastic fixing element 3, the tobacco tar in the second filter 5 will not leak out to the inner wall of the atomization sleeve 1 when it is extruded. Preferably, a first chamfer 33 is provided on the inner lateral edge of the annular step 35 that is facing towards the second filter 5.

Of course, the second filter 5 can be inserted in the elastic fixing element 3 completely, as the elastic fixing element 3 may deform elastically. Preferably, the second filter 5 is partially or completely connected to the atomization sleeve 1 by an interference fit as aforementioned. In this way, the user may apply force to the smoking end as required, and thus the tobacco tar in the second filter 5 may be extruded.

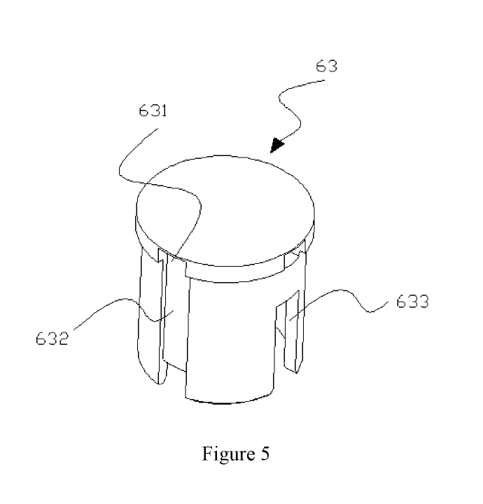

Furthermore, referring to FIG. 1 and FIG. 5, the lamp cap 63 includes a lamp body and an extending portion. The extending portion is hollow and is formed at a circumference of the lamp body with its diameter reduced. The extending portion further extends axially towards the battery sleeve. The lamp body is lucent and can simulate a real cigarette. The battery sleeve is sheathed on the extending portion, the controller 62 is contained in the extending portion, and the lamp body is covered on the battery sleeve. An air inlet groove 631 is defined on the side wall of the lamp body that is facing towards the battery sleeve; wherein the air inlet groove extends to the edge of the lamp body. A breathing groove 632 is defined in the extending portion; wherein the breathing groove passes through the extending portion in the axial direction and is communicated with the air inlet groove 631. A notch 633 is also defined in the extending portion, wherein the notch passes through the extending portion in the longitudinal direction. The notch is configured for wires connected to the controller 62 to pass through. The cross sectional area of the breathing groove 632 is 0.5-3 mm², preferably 1.1-1.5 mm².

The wires of the controller 62 in the lamp cap 63 are connected to the battery after extending out of the notch 633, in order to prevent the wires from pinching off by the lamp cap. During smoking, airflow flows through the air inlet groove 631 and further enters into the second breathing hole or the breathing groove 632. As the breathing groove 632 is connected to the inner space of the battery sleeve, the airflow is guided, so that the smoke atomized by the atomization assembly 2 is delivered to the smoking end with the guided airflow, and the user can smoke. The structure of aforementioned atomization assembly is just for explanation, not for limitation. It can be understood that, any structure can be selected for the atomization assembly to atomize the tobacco tar. Similarly, the structure of the battery rod is not limited here. Any structure can be selected for the battery rod to supply power to the atomization assembly.

Furthermore, the connecting structure between the atomization assembly and the battery rod is not limited here. In the electronic cigarette described in the cases above, an example that the atomization assembly and the battery rod uses a common sleeve (that is, the atomization assembly and the battery rod are integrally formed) is provided. However, in other cases, the atomization assembly and the battery rod can be detachably connected to each other by a connector.

In conclusion, in the electronic cigarette of the present application, a first filter is provided and is capable of filtrating the tobacco tar for the first time, and the drawback that the tobacco tar easily leaks out can be avoided. In the present application, the suction nozzle is replaced by a second filter which may deform elastically while being clamped by the oral cavity of the user. In this way, the electronic cigarette can simulate the tactile sensation of a real cigarette while the user is smoking. Additionally, as the second filter is separated from the first filter, the second filter may not be contaminated by the tobacco tar impurity adsorbed by the first filter, and the drawbacks in prior art that tobacco tar is extruded while the suction nozzle is clamped by the oral cavity of the user or sucking in large particles tobacco tar can be solved. The smoke smoked by the user has little impurity and the taste is pure.

While the present application has been described with reference to preferred embodiments, however, the present application is not limited to above-mentioned embodiments, those modifications, improvements and equivalent substitutions, which don't depart from the scope of the spirit and the principle of the present application, should be included within the scope of the present application.

What is claimed is:

1. An atomizer, configuring to assemble with a battery rod to form an electronic cigarette, the atomizer comprising an atomization sleeve (1) and an atomizer assembly (2) contained in the atomization sleeve (1), one end of the atomizer is configured as a smoking end, wherein a first filter (4) and a second filter (5) separated from each other are provided successively on one end of the atomizer assembly (2) that is close to the smoking end; the first filter (4) is breathable and is configured to prevent tobacco tar in smoke from exhausting; the second filter (5) is configured to discharge the smoke filtrated by the first filter (4); the atomizer assembly (2) and the second filter (5) are provided on two sides of the first filter (4) respectively; the second filter (5) is contained in the smoking end and is made from breathable porous material; wherein the second filter (5) is capable of deforming elastically when subjected to an external force, while the atomizer sleeve (1) is a pipe body which is made from non-metallic materials and is capable of deforming elastically when subjected to an external force.

2. The atomizer according to claim 1, wherein an elastic fixing element (3) is embedded into the atomization sleeve (1) located at the smoking end and is configured to prevent the tobacco tar from leaking out of wall of the atomization sleeve (1); the first filter (4) is contained in the elastic fixing element (3).

3. The atomizer according to claim 2, wherein the elastic fixing element (3) is connected to the atomization sleeve (1) by an interference fit; the elastic fixing element (3) includes a fixing sleeve body (301) coated on the first filter (4), and an elastic sealing layer (302) coated on outer peripheral face of the fixing sleeve body (301); wherein hardness of the fixing sleeve body (301) is greater than hardness of the elastic sealing layer (302).

4. The atomizer according to claim 2, wherein the elastic fixing element (3) is connected to the atomization sleeve (1) by an interference fit, and the elastic fixing element (3) abuts against the atomizer assembly (2).

5. The atomizer according to claim 4, wherein the elastic fixing element (3) includes a smoke inlet facing towards the atomization assembly (2) and a smoke outlet away from the atomization assembly (2), and the smoke inlet and the smoke outlet are arranged coaxially; the first filter (4) is located between the smoke inlet and the smoke outlet; diameter of the smoke inlet is greater than diameter of the smoke outlet, in such a way that the tobacco tar is capable of being exhausted from the smoke inlet when the first filter (4) is extruded.

6. The atomizer according to claim 5, wherein the elastic fixing element (3) is in form of a cylinder; the elastic fixing element (3) includes a resisting portion in form of a disc and a connection portion; the resisting portion abuts against the atomization assembly (2); wherein the connection portion is formed by extending axially in the direction facing towards the second filter (5) from the edge of the resisting portion, and is in form of a hollow cylinder; one end of the connection portion that is away from the resisting portion is configured as the smoke outlet, while the smoke inlet is a breathing hole (30) which is defined in center of the resisting portion and is facing directly towards the atomization assembly (2); the first filter (4) is contained in the connection portion.

7. The atomizer according to claim 6, wherein the second filter (5) is separated from the elastic fixing element (3), wherein the second filter (5) is connected to the atomization sleeve (1) by an interference fit; one end of the second filter (5) that is away from the first filter (4) is at a same level as one end of the atomization sleeve (1), in such a way that a flat surface is formed.

8. The atomizer according to claim 6, wherein the second filter (5) is partially inserted into the elastic fixing element (3), and part of the second filter (5) that extends out of the elastic fixing element (3) is connected to the atomization sleeve (1) by an interference fit;
or the second filter (5) is completely inserted into the elastic fixing element (3).

9. The atomizer according to claim 8, wherein inner wall of the connection portion extends in radial direction in such a way that an annular step (35) is formed; the first filter (4) is contained in the annular step (35); one end of the second filter (5) abuts against the annular step (35), while the other end extends from the elastic fixing element (3), and is at a same level as one end of the atomization sleeve (1), in such a way that a flat surface is formed.

10. The atomizer according to claim 9, wherein a first chamfer (33) is provided on inner lateral edge of the annular step (35) that is facing towards the second filter (5).

11. The atomizer according to claim 6, wherein the atomization assembly (2) includes a heating element (21), a breathing pipe (22) arranged in axial direction of the atomization sleeve (1) and contained in the heating element (21), non-woven fabrics (23) coated on an outer peripheral face of the breathing pipe (22) and oil cottons (24) coated on an outer peripheral face of the non-woven fabrics (23); wherein the breathing hole (30) is directly facing towards the breathing pipe (22), and bore diameter of the breathing hole (30) is less than inside diameter of the breathing pipe (22).

12. The atomizer according to claim 11, wherein a second chamfer (31) is formed at opening of the breathing hole (30) that is facing towards the atomization assembly (2), and the breathing pipe (22) abuts against the second chamfer (31).

13. The atomizer according to claim 11, wherein a third chamfer (32) is formed at opening of the breathing hole (30) that is away from the atomization assembly (2), and is convenient for the tobacco tar in the first filter (4) to flow back.

14. The atomizer according to claim 1, wherein the first filter (4) and the second filter (5) are arranged coaxially along the atomization sleeve (1); a gap is formed between the second filter (5) and the first filter (4), and is configured to deliver the smoke filtrated by the first filter (4) to the second filter (5); axial length of the gap is 1-3 mm.

15. An atomizer, configuring to assemble with a battery rod to form an electronic cigarette, the atomizer comprising an atomization sleeve (1) and an atomizer assembly (2) contained in the atomization sleeve (1), one end of the atomizer is configured as a smoking end, wherein a first filter (4) and a second filter (5) separated from each other are provided successively on one end of the atomizer assembly (2) that is close to the smoking end; the first filter (4) is breathable and is configured to prevent tobacco tar in smoke from exhausting; the second filter (5) is configured to discharge the smoke filtrated by the first filter (4); the atomizer assembly (2) and the second filter (5) are provided on two sides of the first filter (4) respectively; the second filter (5) is contained in the smoking end and is made from breathable porous material; wherein the second filter (5) is capable of deforming elastically when subjected to an external force, while the atomizer sleeve (1) is a pipe body which is made from non-metallic materials and is capable of deforming elastically when subjected to an external force;
wherein an elastic fixing element (3) is embedded into the atomization sleeve (1) located at the smoking end and is configured to prevent the tobacco tar from leaking out of wall of the atomization sleeve (1); the first filter (4) is contained in the elastic fixing element (3); the elastic fixing element (3) is connected to the atomization sleeve (1) by an interference fit; the elastic fixing element (3) includes a fixing sleeve body (301) coated on the first filter (4), and an elastic sealing layer (302) coated on outer peripheral face of the fixing sleeve body (301); wherein hardness of the fixing sleeve body (301) is greater than hardness of the elastic sealing layer (302);
wherein the elastic fixing element (3) includes a smoke inlet facing towards the atomization assembly (2) and a smoke outlet away from the atomization assembly (2), and the smoke inlet and the smoke outlet are arranged coaxially; the first filter (4) is located between the smoke inlet and the smoke outlet; diameter of the smoke inlet is greater than diameter of the smoke outlet, in such a way that the tobacco tar is capable of being exhausted from the smoke inlet when the first filter (4) is extruded; and
wherein the fixing sleeve body (301) is in form of a cylinder and includes a resisting portion in form of a disc and a connection portion; the resisting portion abuts against the atomization assembly (2); the connection portion is formed by extending axially in direction facing towards the second filter (5) from edge of the resisting portion, and is in form of a hollow cylinder; one end of the connection portion that is away from the resisting portion is configured as the smoke outlet; the smoke inlet is a breathing hole which is defined in center of the resisting portion and is facing directly towards the atomization assembly (2); the first filter (4) is contained in the connection portion.

16. An electronic cigarette, comprising an atomizer and a battery rod connected to each other; wherein the atomizer comprises an atomization sleeve (1) and an atomizer assembly (2) contained in the atomization sleeve (1), one end of the atomizer is configured as a smoking end, wherein a first filter (4) and a second filter (5) separated from each other are provided successively on one end of the atomizer assembly that is close to the smoking end; the first filter (4) is breathable and is configured to prevent tobacco tar in smoke from exhausting; the second filter (5) is configured to discharge the smoke filtrated by the first filter (4); the atomizer assembly (2) and the second filter (5) are provided on two sides of the first filter (4) respectively; the second filter (5) is contained in the smoking end and is made from breathable porous material; wherein the second filter (5) is capable of deforming elastically when subjected to an external force, while the atomizer sleeve (1) is a pipe body which is made from non-metallic materials and is capable of deforming elastically when subjected to an external force.

17. The electronic cigarette according to claim 16, wherein an elastic fixing element (3) is embedded into the atomization sleeve (1) located at the smoking end and is configured to prevent the tobacco tar from leaking out of wall of the atomization sleeve (1); the first filter (4) is contained in the elastic fixing element (3).

18. The electronic cigarette according to claim 17, wherein the elastic fixing element (3) is connected to the atomization sleeve (1) by an interference fit; the elastic fixing element (3) includes a fixing sleeve body (301) coated on the first filter (4) and an elastic sealing layer (302) coated on outer peripheral face of the fixing sleeve body (301); wherein hardness of the fixing sleeve body (301) is greater than hardness of the elastic sealing layer (302).

19. The electronic cigarette according to claim 17, wherein the elastic fixing element (3) is connected to the atomization sleeve (1) by an interference fit, and the elastic fixing element (3) abuts against the atomizer assembly (2);
the elastic fixing element (3) includes a smoke inlet facing towards the atomization assembly (2) and a smoke outlet away from the atomization assembly (2), and the smoke inlet and the smoke outlet are arranged coaxially; the first filter (4) is located between the smoke inlet and the smoke outlet; diameter of the smoke inlet is greater than diameter of the smoke outlet, in such a way that the tobacco tar is capable of being exhausted from the smoke inlet when the first filter (4) is extruded; the elastic fixing element (3) is in form of a cylinder; the elastic fixing element (3) includes a resisting portion in form of a disc and a connection portion; the resisting portion abuts against the atomization assembly (2); wherein the connection portion is formed by extending axially in direction facing towards the second filter (5) from edge of the resisting portion, and is in form of a hollow cylinder; one end of the connection portion that is away from the resisting portion is configured as the smoke outlet, while the smoke inlet is a breathing hole (30) which is defined in center of the resisting portion and is facing directly towards the atomization assembly (2); the first filter (4) is contained in the connection portion;
axial length of the gap between the second filter (5) and the first filter (4) is 1-3 mm.

20. The electronic cigarette according to claim 16, wherein the battery rod includes a battery sleeve, a battery (61) contained in the battery sleeve, a lamp cap (63) inserted in one end of the battery sleeve that is away from the atomizer, and a controller (62) embedded into the lamp cap (63);
the battery sleeve is integrated with the atomization sleeve (1); the battery sleeve and the atomization sleeve (1) are made from plastic material;
the lamp cap (63) includes a lamp body and an extending portion; the extending portion is hollow and is formed at a circumference of the lamp body with its diameter reduced; and the extending portion extends axially towards the battery sleeve; the battery sleeve is sheathed on the extending portion; the controller (62) is contained in the extending portion, and the lamp body is covered on the battery sleeve; an air inlet groove (631) is defined on side wall of the lamp body that is facing towards the battery sleeve, wherein the air inlet groove extends to edge of the lamp body; a breathing groove (632) is defined on the extending portion, wherein the breathing groove (632) passes through the extending portion in axial direction and is communicated with the air inlet groove (631); a notch (633) is defined in the extending portion, wherein the notch (633) passes through the extending portion in longitudinal direction and is configured for wires connected to the controller (62) to pass through.
